(19) United States
(12) Patent Application Publication
(10) Pub. No.: US 2026/0112016 A1
(43) Pub. Date: Apr. 23, 2026

(54) METHODS AND SYSTEMS FOR CONTENT-BASED MEDIA ATTRIBUTE ASSESSMENT

(71) Applicant: Google LLC, Mountain View, CA (US)

(72) Inventors: Yilin Wang, Sunnyvale, CA (US); Wen Wen, Mountain View, CA (US); Neil Aylon Charles Birkbeck, Santa Cruz, CA (US); Balineedu Chowdary Adsumilli, Sunnyvale, CA (US)

(21) Appl. No.: 19/363,515

(22) Filed: Oct. 20, 2025

Related U.S. Application Data
(60) Provisional application No. 63/709,735, filed on Oct. 21, 2024.

(51) Int. Cl. G06T 7/00; G06N 3/048

(52) U.S. Cl. CPC G06T 7/0002; G06N 3/048; G06T 2207/30168

(57) ABSTRACT

Methods and systems for content-based media attribute assessment. A media item including a set of video frames each including initial content associated with a content type is identified. A spatial transformation operation with respect to the set of video frames to obtain a set of spatially transformed video frames is performed. One or more video frames of the set of spatially transformed video frames including transformed content that satisfies one or more quality criteria are identified. A set of model weights associated with the transformed content of the identified one or more video frames is determined. A model pipeline associated with a content sharing platform is modified to include the set of model weights for application to outputs of one or more artificial intelligence (AI) models trained to predict quality metrics associated with media items including content having the content type.

### RELATED APPLICATIONS

This non-provisional application claims priority to U.S. Provisional Patent Application No. 63/709,735, filed Oct. 21, 2024, entitled “A GENERAL FRAMEWORK TO IMPROVE RELIABILITY OF NO-REFERENCE BASED VIDEO QUALITY METRICS,” which is incorporated herein by reference in its entirety for all purposes.

### TECHNICAL FIELD

Aspects and implementations of the present disclosure relate to content-based media attribute assessment.

### BACKGROUND

Content sharing platforms provide media items, such as videos, audio, images, etc., to client devices over a network. These platforms often evaluate attributes of media items to optimize user experience, ensure efficient content delivery, improve transcoding and compression, enhance content discovery and recommendation, and so forth. In some cases, a platform may determine the quality of a media item using one or more artificial intelligence (AI) models trained to quality metrics for media items.

### SUMMARY

The summary below is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying a media item including a set of video frames each including initial content associated with a content type. The method further includes performing a spatial transformation operation with respect to the set of video frames to obtain a set of spatially transformed video frames. The method further includes identifying one or more video frames of the set of spatially transformed video frames including transformed content that satisfies one or more quality criteria. The method further includes determining a set of model weights associated with the transformed content of the identified one or more video frames. The method further includes modifying a model pipeline associated with a content sharing platform to include the set of model weights for application to outputs of one or more artificial intelligence (AI) models trained to predict quality metrics associated with media items including content having the content type.

In some implementations, determining the set of model weights associated with the transformed content includes providing the transformed content as an input to an additional AI model trained to predict model weights associated with given content. The method further includes obtaining one or more outputs of the additional AI model. The method further includes extracting the set of model weights associated with the transformed content from the obtained one or more outputs of the additional AI model.

In some implementations, the additional AI model includes a multilayer perceptron model including one or more of a set of layers having rectified linear unit (ReLU) non-linearity or a sigmoid layer.

In some implementations, the method further includes providing the transformed content as an input to a vision encoder. The method further includes obtaining one or more outputs of the vision encoder, the one or more outputs including a set of visual features representing the transformed content. The set of model weights associated with the transformed content is determined based on the set of visual features.

In some implementations, the method further includes providing the set of visual features as an input to a concatenation operation. The method further includes obtaining one or more outputs of the concatenation operation. The one or more outputs include a concatenated matrix representing the set of visual features.

In some implementations, the method further includes providing the concatenated matrix as an input to a spatial pooling operation. The method further includes obtaining one or more outputs of the spatial pooling operation. The one or more outputs include a concatenated vector representing the set of visual features based on the concatenated matrix. The set of model weights associated with the transformed content is determined based on the concatenated vector.

In some implementations, the spatial transformation operation includes at least one of a resizing operation, a stretching operation, a compression operation, or a cropping operation.

In some implementations, the method further includes identifying one or more video frames of the set of spatially transformed video frames including transformed content that satisfies one or more quality criteria includes at least one of determining that a difference between a visual quality of the transformed content of the one or more video frames and a visual quality of the initial content of the set of video frames falls below a threshold difference, determining that the visual quality of the transformed content of the one or more video frames exceeds a threshold visual quality, or determining that the visual quality of the transformed content of the one or more video frames is higher than a visual quality of transformed content of one or more additional video frames of the set of spatially transformed video frames.

In some implementations, the content type includes at least one of a short-form content type, a long-form content type, a user-generated content type, a live-stream content type, an animated content type, a computer generated image (CGI) content type, an archival content type, or a restored content type.

In some implementations, the method further includes receiving a request for a quality metric associated with an additional media item that includes content associated with the content type. The method further includes providing the additional media item as an input to one or more AI models. The method further includes obtaining an output of the one or more AI models, the output including one or more quality metrics associated with the additional media item. The method further includes applying the set of model weights to the one or more quality metrics associated with the additional media item to obtain an updated quality metric in view of the content type.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example media attribute engine, in accordance with implementations of the present disclosure.

FIG. 3 is a block diagram of an example method for obtaining model weights for content-based media attribute assessment, in accordance with implementations of the present disclosure.

FIG. 4 is a block diagram of an example of content-based media attribute assessment, in accordance with implementations of the present disclosure.

FIG. 5 is a block diagram of an example method for content-based media attribute assessment, in accordance with implementations of the present disclosure.

FIG. 6 is a block diagram of an example predictive system, in accordance with implementations of the present disclosure.

FIG. 7 is a block diagram illustrating an exemplary computer system, in accordance with implementations of the present disclosure.

### DETAILED DESCRIPTION OF THE DRAWINGS

Aspects of the present disclosure generally relate to content-based media attribute assessment. Platforms (e.g., a content sharing platform) can enable users to share media items (e.g., video items, audio items, etc.) with other users. Such platforms handle a vast and ever-growing volume of media items, which are provided by a significant number of users (e.g., millions) daily. Due to the scale and diversity of such user-provided media items, platforms operate in a dynamic environment and prioritize maintaining a high quality experience for end users, which involves processing, storing, and delivering media items efficiently and effectively across a wide array of client devices and network conditions. This involves complex operations such as transcoding media into different formats and bitrates, applying compression to save bandwidth and storage, and selecting the optimal version of a media item to serve to a user.

The effective and efficient curation and distribution of content to a large audience depends on the quality (e.g., perceptual quality, technical quality, etc.) of such content. For example, within a content delivery pipeline, a platform may use or otherwise consider the quality of a media item (e.g., bitrate, resolution, presence of compression artifacts, etc.) to select a transcoding technique or transcoding settings for the media item, for adaptive bitrate streaming optimization (e.g., that adjust video resolution based on network conditions), to perform content ranking and recommendation, to perform automated content enhancement (e.g., sharpening or color correction, etc.), and so forth. In some instances, an inaccurate quality metric or other such attribute can lead a platform to select an inefficient compression scheme that wastes storage and bandwidth by encoding at a needlessly high bitrate or degrading the media item unnecessarily. In other instances, a platform may apply detrimental transformations to content of a media item based on flawed quality feedback. Accordingly, the accurate and reliable assessment of quality and other such attributes impacts the efficient and effective operation of the media processing and delivery infrastructure of a content sharing platform.

Conventionally, platforms assess media quality using reference-based metrics, which involves comparing a processed media item (e.g., which has been compressed, enhanced, resized, scaled, etc.) to its original (e.g., pristine) version to quantify degradation caused by (or related to) the processing. However, in the context of user-provided media items, a pristine, original version of a media item is frequently unavailable. Accordingly, some platforms implement no-reference quality assessment techniques, which sometimes involve using artificial intelligence (AI) models trained to predict quality metrics or other attributes associated with media items. Such AI models (referred to as media item attribute AI models) are typically trained on large datasets that have been manually rated (e.g., by humans) to generate ground truth quality metrics.

A conventional system may train a media item attribute AI model using a dataset including media items and labels (e.g., obtained by humans or by pseudo-ground truth techniques) indicating the attribute (e.g., quality metric) associated with each media item. As users provide significantly large numbers of media items (e.g., millions) to a content sharing platform daily, it is difficult for the system to identify media items that are suitable for use in training such AI model and also represent diverse content, editing styles, and/or unique artifacts of the user-provided media items. Accordingly, the training dataset used for training a media item attribute AI model may not include training media items and corresponding labels reflecting such diverse content, editing styles, and/or unique artifacts, and the model may therefore be unable to accurately and reliably predict or otherwise estimate media attributes associated with such types of content.

Unreliable and inaccurate quality metrics (and other such attributes) obtained using conventionally trained AI models can impact the overall performance and user experience associated with a content sharing platform. A platform relying on unreliable and inaccurate quality metrics may unnecessarily initiate computationally expensive operations that, in some instances, are actively harmful. For example, a platform relying on a low quality metric for a high-quality 4K media item may initiate an unnecessary transcoding process, which consumes significant processing cycles and memory space to create a redundant or lower-quality variant. In another example, a platform relying on a low quality metric for a high quality media item may apply a series of unnecessary enhancement filters (e.g., sharpening or color correction), each of which consumes processing power on operations that yield no (or minor) perceptible improvement.

Embodiments of the present disclosure provide techniques for content-based media attribute assessment. A platform identifies a media item including a set of video frames that each include content associated with a content type. The content type can include, for example, short-form content type (e.g., having a duration that falls below a threshold duration), a long-form content type (e.g., having a duration that exceeds the threshold duration and is visually or audibly rich), a user-generated content type (e.g., content that is created and shared by individual users of the platform), a live-stream content type (e.g., content that is broadcast in real-time as an event occurs), an animated content type, a computer generated image (CGI) content type, an archival content type (e.g., including historical media, such as film footage, television broadcasts, video recording, and so forth and has been converted to a digital form), a restored content type (e.g., degraded media that has undergone a digital restoration process), and so forth.

The platform can perform one or more spatial transformation operations with respect to the set of video frames to obtain a set of spatially transformed video frames. A spatial transformation operation refers to an operation that modifies the spatial properties of a video frame. Example spatial transformation operations can include, but are not limited to, a resizing operation (e.g., changing the dimensions, such as height and width, of a video frame), a stretching operation (e.g., distorting the aspect ratio of content of a video frame), a compression operation (e.g., reducing the size of the video frame, sometimes affecting spatial characteristics), a cropping operation (e.g., selecting and extracting content of a specific region of a video frame), and so forth. In some embodiments, the spatial transformation operation is performed with respect to each video frame of the set of video frames to generate a corresponding spatially transformed video frame.

The platform can identify one or more video frames of the set of spatially transformed video frames that includes transformed content that satisfies one or more quality criteria. In some embodiments, the platform can provide each of the set of video frames and each of the set of spatially transformed video frames as inputs to one or more AI models trained to predict a quality metric associated with given content. The platform can obtain quality metrics associated with each of the set of video frames and each of the set of spatially transformed video frames, which may reflect the visual quality for each respective frame before and after the performance of the spatial transformation operation. In some embodiments, transformed content can satisfy the quality criteria if a difference between a visual quality of the transformed content of a respective video frame and the visual quality of the original content (e.g., prior to the performance of the spatial transformation operation) falls below a threshold difference. In additional or alternative embodiments, transformed content can satisfy the quality criteria if the visual quality of the transformed content of the one or more video frames exceeds a threshold visual quality. In yet additional or alternative embodiments, transformed content can satisfy the quality criteria if the visual quality of the transformed content of the one or more video frames is higher than a visual quality of transformed content of additional video frames of the set of spatially transformed video frames. Further details regarding identifying video frames that satisfy the quality criteria are provided herein.

The platform can determine a set of model weights associated with the transformed content of the identified one or more video frames. The model weights represent a dynamic, content aware correction factor that can be used to adjust a final quality metric (or other such attribute) based on a particular type of content being analyzed by a media item attribute AI model. In some embodiments, the platform can determine the set of model weights by providing the identified one or more video frames as an input to a vision encoder, which analyzes the video frame(s) and extracts visual features (e.g., shapes, colors, textures, objects, etc.) from the analyzed video frame(s). The platform provides the extracted visual features as an input to a concatenation operation and obtains one or more outputs of the concatenation operation, which include a concatenated matrix representing the visual features. The platform provides the concatenated matrix as an input to a spatial pooling operation, and obtains one or more outputs of the spatial pooling operation, which include a concatenated vector representing the visual features based on the concatenated matrix. The platform can provide the concatenated vector as an input to an additional AI model (e.g., a multilayer perceptron (MLP) model) and can obtain one or more outputs of the additional AI model, the output(s) including the set of model weights associated with the transformed content. Further details regarding determining the set of model weights are provided herein.

The platform can update a model pipeline to include the set of model weights for application to output(s) of one or more AI models that are trained to predict media attributes (e.g., quality metrics) associated with media items that include content having the content type. In some embodiments, the platform can update the model pipeline to include a content-based quality metric component, which analyzes content of a given media item (e.g., provided by a user of the platform) to determine a content type associated with the media item and identify a set of model weights obtained for such content type. Upon obtaining an output of the one or more AI models, the content-based ensemble component can apply the set of model weights to a media attribute (e.g., quality metric) obtained based on the output to obtain an updated or adjusted media attribute in view of the content type. In an illustrative example, the platform can obtain a set of model weights associated with content having a short-form content type, as described herein. Upon receiving a request for a quality metric associated with a media item having the short-form content type (e.g., provided by a user of the platform), the platform can provide the media item as an input to the one or more AI models and obtain the quality metric based on one or more outputs of the AI model. The platform can apply the set of model weights associated with the short-form content type to the quality metric to determine an updated quality metric that reflects the quality (e.g., visual, technical, etc.) quality of the media item in view of the short-form content type.

Implementations of the present disclosure address the above and other deficiencies by providing techniques to adjust quality metrics and/or other such media attributes obtained for media items using AI models in accordance with a type of content associated with the media items. As described herein, embodiments of the present disclosure offer a dynamic weighting system that enables a platform to adjust the output of a trained AI model to accurately and reliably reflect a quality (or other attributes) of a given media item associated with a content type to which the trained AI model has no or little exposure. By obtaining content-based weights for application to outputs of the trained AI model, embodiments of the present disclosure offer improved, flexible, and efficient media attribute assessment capabilities that avoids the resource intensive and time-consuming process of collecting new datasets and retraining large scale AI models every time a new content type emerges or is identified as being poorly handled.

As the platform is able to obtain more reliable and consistent quality metrics, the platform, relying on such metrics, can perform appropriate operations with respect to media items using appropriate operation settings, which can improve the overall performance and user experience associated with the platform. For example, based on a low quality metric obtained for a media item using the content-based model weights, the platform may apply a series of enhancement filters (e.g., sharpening or color correction) using settings that accurately reflect the targeted quality improvement associated with the media item, which may significantly improve the perceptual quality of the media item. In another example, the platform may determine, based on a high quality metric obtained for a media item using the content-based model weights, that the media item can be distributed without the performance of computationally expensive operations (e.g., transcoding operations, enhancement operations, etc.). The computing resources (e.g., processing cycles, memory space, network bandwidth, power, etc.) that would have been consumed by such computationally expensive operations can be available to other processes of the system, which improves an overall efficiency and decreases an overall latency of the system.

It should be noted that although some embodiments and examples of the present disclosure are directed to quality metrics associated with media items of a content sharing platform, such embodiments and examples can be applied to other metrics associated with media items of other platforms or systems. For example, embodiments and examples of the present disclosure can be applied to content relevance metrics, user experience metrics, media item playback performance metrics, and so forth.

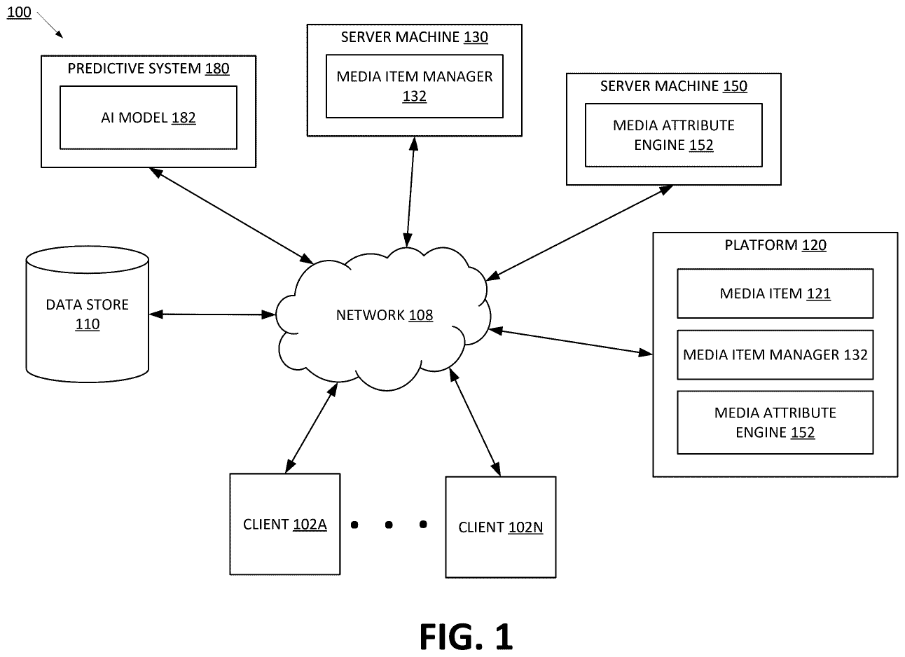

FIG. 1 illustrates an example system architecture 100, in accordance with implementations of the present disclosure. example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated with media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Media attribute engine 152 can determine one or more media attributes of a media item 121, which may be used for various purposes by platform 120. Media attributes can include, but are not limited to, quality metrics (e.g., indicating a perceptual or technical quality of a media item 121), relevance metrics (e.g., indicating a relevance of content of a media item 121 to a topic), user experience metrics (e.g., indicating or quantifying a user experience or predicted user experience associated with the media item 121), media item playback performance (e.g., indicating or quantifying a playback performance or predicted playback performance associated with the media item 121), and so forth. Example use cases associated with media attributes include, for example, encoding optimization (e.g., selecting a codec and/or encoding settings for media items 121), storage management (e.g., allocating storage tiers depending on quality and expected demand), transcoding (e.g., triggering encoding or re-encoding of media items 121 that fall below quality thresholds), content indexing and retrieval (e.g., structuring content or metadata in distributed databases to support low-latency search), recommendation engine training (e.g., feeding relevance metrics into recommender models for ranking), cache placement (e.g., prefetching and caching content that is predicted to be most relevant in a given geographic region or to particular groups of users), UI adaptation (e.g., dynamically adjusting layout, font size, captioning options, etc. to improve user experience and/or for accessibility), model feedback loops (e.g., using implicit engagement signals to retrain personalization models), client device-specific tuning (e.g., modifying UI or playback parameters depending on device constraints), adaptive bitrate control (e.g., switching streams of media items 121 in real-time or approximately real-time based on available bandwidth), load balancing (e.g., redirecting playback requests across multiple edge nodes of system 100 depending on congestion), error detection and recovery (e.g., automatically retrying streams or swapping protocols when errors are detected), telemetry-driven scaling (e.g., using playback metrics to trigger autoscaling of computing resources during peak demand), and so forth.

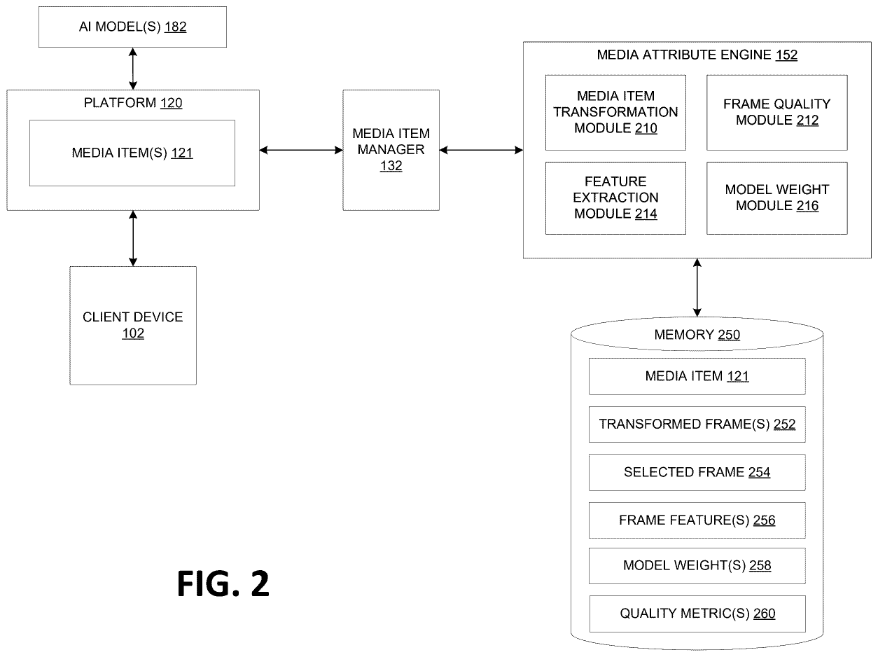

Media attribute engine 152 may determine or otherwise obtain media attribute(s) associated with a media item 121 using one or more AI models 182 of predictive system 180. In some embodiments, predictive system 180 can include one or more AI models 182 that are each trained to predict a respective media item attribute of a given media item 121. In other or similar embodiments, one or more AI models 182 of predictive system 180 may be trained to predict multiple media item attributes. As described herein, media attribute engine 152 can obtain training data that can be used to retrain AI model(s) 182 to improve the accuracy and reliability of media attribute predictions of AI model(s) 182). Further details regarding retraining AI model(s) 182 are provided below with respect to FIGS. 2-6.

In accordance with embodiments described herein, an AI model 182 can be trained to predict a quality metric associated with a given media item 121. Such AI model 182 can include, but is not limited to, a video quality assessment (VQA) model (e.g., a no-reference VQA model, a full-reference VQA model), a neural network (e.g., a convolutional neural network (CNN) based model, a recurrent neural network (RNN) or long short-term memory (LSTM) based model, a transformer-based model, etc.), a quality of experience (QoE) prediction model (e.g., a supervised machine learning model, a reinforcement model, a hybrid model, etc.), and so forth. It should be noted that although some embodiments and examples of the present disclosure refer to training and/or retraining an AI model for improved predictions of quality metrics associated with a media item 121, such embodiments can be applied to non-AI models that predict or otherwise obtain quality metrics associated with media items 121, such as signal processing-based models (e.g., peak signal-to-noise (PSNR) models, structural similarity index (SSIM) models, multi-scale SSIM models, visual information fidelity (VIF) models, etc.), bitstream and encoding heuristic models or engines (e.g., bitrate-to-resolution ratios heuristic models, quantization parameter (QP) models, group of pictures (GOP)/frame-level models), mathematical and/or statistical models (e.g., regression models, exponential/logarithmic decay models, utility functions, etc.), network performance models (e.g., buffering probability models, startup delay models, Markov models, etc.), and so forth.

It should be noted that although FIG. 1 illustrates media attribute engine 152 as part of platform 120, in additional or alternative embodiments, media attribute engine 152 can reside on one or more server machines or systems that are remote from platform 120 (e.g., server machine 130, server machine 150). It should be noted that in some other implementations, the functions of server machines 150, predictive system 180 and/or platform 120 can be provided by a fewer number of machines. For example, in some implementations, components and/or modules of any of server machine 130, server machine 150, and/or predictive system 180 may be integrated into a single machine, while in other implementations components and/or modules of any of server machine 130, server machine 150, and/or predictive system 180 may be integrated into multiple machines. In addition, in some implementations, components and/or modules of any of server machine 130, server machine 150 and/or predictive system 180 may be integrated into platform 120.

In general, functions described in implementations as being performed by platform 120, server machines 130, 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 illustrates an example media attribute engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102.

As described herein, media attribute engine 152 can determine one or more media attributes of a media item 121. Media attributes can include, but are not limited to, quality metrics, relevance metrics, user experience metrics, media item playback performance metrics, and so forth. In some embodiments, media attribute engine 152 can obtain the media attributes of media item 121 based on one or more outputs of an AI model 182 trained to predict media attributes of given media items 121. Media attribute engine 152 can additionally or alternatively determine content-based model weights to be applied to predicted media attributes obtained based on the output(s) of AI model 182, as described herein.

As illustrated in FIG. 2, media attribute engine 152 can include a media item transformation module 210, a frame quality module 212, a feature extraction module 214, and/or a model weight module 216. Details regarding determination of content-based model weights are provided herein with respect to FIGS. 2-6. In some embodiments, platform 120, media item manager 132, and/or media attribute 152 can be connected to memory 250 (e.g., via network 108, via a bus, etc.). Memory 250 can correspond to one or more regions of data store 110, in some embodiments. In other or similar embodiments, one or more portions of memory 250 can include or otherwise correspond to any memory of or connected to system 100. It should be noted that some embodiments and examples of the present disclosure are directed to obtaining and retraining an AI model 182 for improved prediction of quality metrics 260. However, such embodiments and examples are not intended to be limiting and are provided for the purpose of example and illustration only. Embodiments and examples can be applied to AI models 182 that predict any type of media item metric, as described herein.

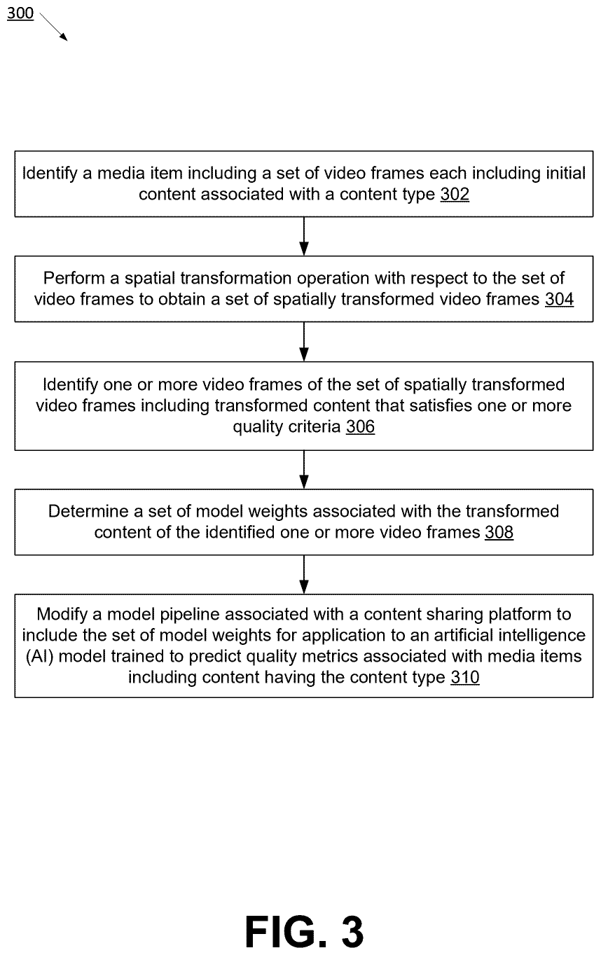

FIG. 3 is a block diagram of an example method 300 for obtaining model weights for content-based media attribute assessment, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by media attribute engine 152 and/or one or more components of predictive system 180.

At block 302, processing logic identifies a media item including a set of video frames each including initial content associated with a content type. In some embodiments, media item transformation module 210 can identify the media item 121 including video frames including content associated with the content type. As described above, a content type can include, but is not limited to, short-form content type (e.g., having a duration that falls below a threshold duration), a long-form content type (e.g., having a duration that exceeds the threshold duration and is visually or audibly rich), a user-generated content type (e.g., content that is created and shared by individual users of the platform), a live-stream content type (e.g., content that is broadcast in real-time as an event occurs), an animated content type, a computer generated image (CGI) content type, an archival content type (e.g., including historical media, such as film footage, television broadcasts, video recording, and so forth and has been converted to a digital form), a restored content type (e.g., degraded media that has undergone a digital restoration process), etc., in some embodiments.

Media item transformation module 210 may identify the media item 121 associated with the content type from a data store (e.g., data store 110) that stores media items 121 provided by users of platform 120. In other or similar embodiments, media transformation module 210 may identify the media item 121 from a training data set including media items 121 identified or otherwise associated with training an AI model 182 to predict media attributes based on given content. In some embodiments, media item transformation module 210 may determine that a media item 121 (e.g., of data store 110, of the training data set, etc.) is associated with the content type by extracting metadata associated with the media item 121 (e.g., tags, titles, descriptions, channel information, etc.) which may indicate the content type associated with the media item 121. Such metadata may be provided by a user associated with the media item 121 (e.g., the user that provided the media item 121), a user who has accessed or otherwise consumed the media item 121 (e.g., other than the user that provided the media item 121), and/or a developer or operator of system 100. In other or similar embodiments, media item transformation module 210 may provide the media item 121 as an input to a computer vision and/or audio analysis model (not shown) and classify the content based on characteristics identified by the computer vision and/or audio analysis model (e.g., indicated in the model output(s)). In yet other or similar embodiments, media item transformation module 210 may determine the content type associated with the media item 121 by providing the media item 121 as an input to an AI model (e.g., associated with predictive system 180 or another component of system 100) that is trained to predict a content type associated with given content. Such AI model may be trained to distinguish between animated content, CGI, archival footage, user-generated content, etc. by recognizing distinct visual styles, frame rates, color palettes, or audio patterns.

At block 304, processing logic performs a spatial transformation operation with respect to the set of video frames to obtain a set of spatially transformed video frames. Once a media item 121 is identified, media item transformation module 210 can perform one or more spatial transformation operations with respect to the video frames of the media item 121. A spatial transformation operation can include any operation that modifies the spatial properties of an image or video, such as its dimensions, orientation, or aspect ratio. Example spatial transformation operations include, but are not limited to, resizing operations, cropping operations, stretching operations, compression operations, and so forth. A resizing operation can alter the height and width of the video frames of media item 121, either proportionally or non-proportionally. A cropping operation can involve selecting and extracting a specific region of a video frame, which effectively changes the video frame's composition. A stretching operation can distort an aspect ratio of the video frame. A compression operation can reduce a data size of the video frame and introduce compression artifacts, which can affect spatial details of content of the video frame. In some embodiments, media item transformation module 210 may select a particular transformation operation to be performed with respect to video frames of a media item 121 based on conditions or constraints of AI model 182 or other downstream models (e.g., a video encoder) which may process the transformed video frames.

Media item transformation module 210 can provide each video frame of media item 121 as an input to the spatial transformation operation and obtain an output of the operation, which includes a video frame that has been spatially transformed in accordance with the operation. Upon providing each video frame of media item 121 as an input to the spatial transformation operation, media item transformation module 210 can obtain a set of transformed frames 252, as described herein. In an illustrative example, media item transformation module 210 may provide video frames of a media item 121 as an input to a spatial resizing operation, which transforms the video frames from the original size of 1920×1080 pixels to a size of 448×448 pixels. Such spatial resizing may be performed using bilinear interpolation techniques, which may not preserve the original aspect ratio associated with the media item 121.

At block 306, processing logic identifies one or more video frames of the set of spatially transformed video frames including transformed content that satisfies one or more quality criteria. In some embodiments, frame quality module 212 can identify the one or more video frames of the transformed frames 252 that satisfy the quality criteria. At least one criterion of the quality criteria can include a value representing a threshold difference between a quality metric 260 of content of an original video frame of media item 121 and a quality metric 260 of transformed content of a corresponding transformed video frame 252. In some embodiments, frame quality module 212 can provide the original video frames of media item 121 as an input to AI model 182 and obtain one or more outputs of AI model 182, which can indicate, for each video frame, a quality metric 260 associated with the respective video frame. Frame quality module 212 can also provide the transformed video frames 252 as an input to AI model 182 and obtain one or more outputs, which can indicate, for each transformed video frame 252, a quality metric 260 associated with the respective transformed video frame 252. In some embodiments, frame quality module 212 can determine a difference between the quality metric 260 associated with the original video frame and the quality metric 260 associated with the corresponding transformed video frame 252 and, upon determining that the difference falls below the threshold difference, can determine that the criterion of the quality criteria is satisfied. By satisfying such criterion of the quality criteria, frame quality module 212 determines that the transformation operation applied to the original video frame did not impact (or did not have a significant impact on) the quality (e.g., the visual quality, the technical quality, etc.) of the content of the original video frame.

In some embodiments, an additional or alternative criterion of the quality criteria can relate to the absolute level of quality associated with the transformed content of the transformed video frame(s) 252. For example, frame quality module 212 can determine whether a quality metric 260 determined for a transformed video frame 252 (e.g., based on output(s) of AI model 182 described above) meets or exceeds a threshold quality metric and, if so, can determine that the quality criteria are satisfied. In yet other or similar embodiments, an additional alternative criterion of the quality criteria can relate to a comparative analysis of the quality metrics 260 determined for each of the transformed video frames 252. For example, frame quality module 212 can compare quality metrics 260 for each transformed video frame 252 and determine that a particular number of transformed video frames 252 having a highest quality metric 260 satisfy the quality criteria. It should be noted that frame quality module 212 can apply any or all of the above described quality criteria in identifying or otherwise selecting a transformed video frame 252, as described herein.

At block 308, processing logic determines a set of model weights associated with the transformed content of the identified one or more video frames. As described above, upon identifying one or more transformed video frames 252 including transformed content that satisfies the one or more quality criteria, feature extraction module 214 can select such identified video frames 252 for use in determining the set of model weights associated with the content type of the media item 121. Such selected video frames 252 are referred to below as selected video frame(s) 254.

In some embodiments, feature extraction module 214 can provide the selected frame 254 as an input to a model that is trained or otherwise configured to identify visual features associated with given content. Such model can include a vision encoder 402, in some embodiments, but can include any other type of AI model or non-AI model that is capable of identifying such visual features, in accordance with embodiments of the present disclosure. A vision encoder 402 refers to a specialized model that may be derived from a larger multimodal model and is trained to extract a rich set of visual features from given image or video frames. Such features can include, but are not limited to, objects, textures, colors, spatial arrangements, etc. In some embodiments, vision encoder 402 can include, but is not limited to, a general purpose vision encoder, a transformer-based vision encoder, a multimodal and/or pretrained encoder, a specialized video encoder, and so forth. Feature extraction module 214 can obtain one or more outputs of the vision encoder 402, which includes a high-dimensional representation of the visual features extracted by vision encoder 402 for selected frame 254.

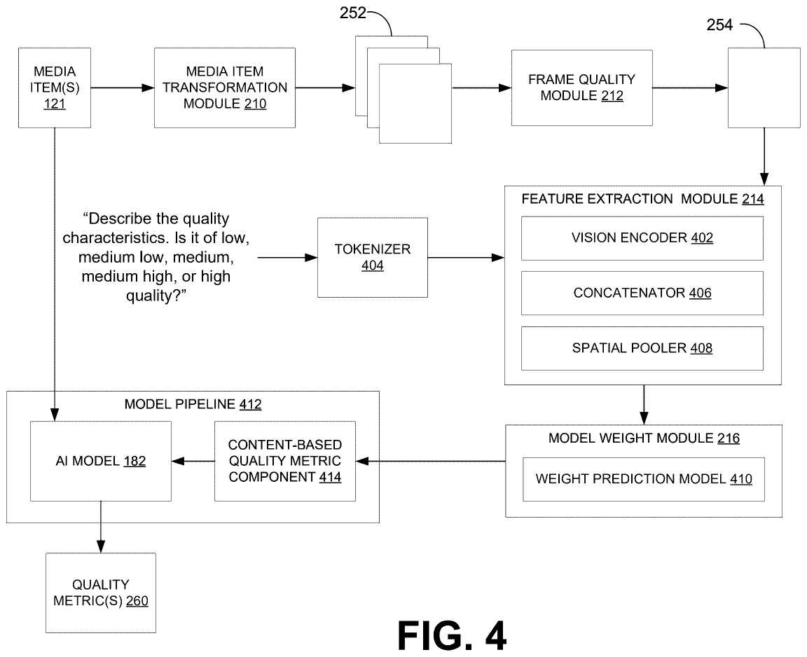

In some embodiments, a developer or operator of system 100 can provide a natural language query via a client device (e.g., a client device 102) including a query pertaining to the quality of the selected video frame 254. In an illustrative example, the query can be “Describe the quality characteristics. Is it of low, medium low, medium, medium high, or high quality?” as illustrated by FIG. 4. Media attribute engine 152 may provide the natural language query as an input to a tokenizer 404, which is a component (e.g., of a natural language processing (NLP) system) that converts raw text into a sequence of smaller units referred to as tokens. In some embodiments, tokenizer 404 can include a subword-based tokenizer (e.g., that breaks words into subword tokens), a character/byte-level tokenizer (e.g., that breaks an input into character tokens or raw byte tokens), a word-level tokenizer (e.g., that breaks an input into word tokens), or a specialized tokenizer (e.g., that breaks an input into other types of token in accordance with a special purpose associated with the tokenizer). Media attribute engine 152 can obtain an output of the tokenizer 404, which includes a set of tokens generated based on the provided natural language query, and provides the set of tokens to feature extraction module 214.

Concatenator 406 of feature extraction module 214 can obtain a concatenated matrix based on the visual features and/or the tokens described above. A concatenation operation refers to an operation that joins two or more sequences of data end-to-end along a specified dimension. In some embodiments, concatenator 406 can provide the visual features and/or the tokens as an input to the concatenation operation, along with an indication of a dimension to be applied for the output of the concatenation operation (e.g., as defined by a protocol associated with system 100 and/or provided by a developer or operator of system 100). Concatenator 406 can obtain one or more outputs which includes a concatenated matrix representing the visual features and/or the tokens, where the concatenated matrix has the specified dimension.

Upon obtaining the concatenated matrix, spatial pooler 408 of feature extraction module 214 can provide the concatenated matrix as an input to a spatial pooling operation. A spatial pooling operation refers to an operation that reduces the spatial dimensions (e.g., height x width) of a feature map (e.g., a matrix) while retaining the most salient information. A spatial pooling operation can include, but is not limited to, a max pooling operation (e.g., which determines the maximum value in a region of a given matrix), an average pooling operation (e.g., which determines the mean value in a region of a given matrix), or a global pooling operation (e.g., which aggregates over the entire spatial dimension of the given matrix to produce a single feature). Spatial pooler 408 can obtain one or more outputs of the spatial pooling operation, which can include a concatenated vector representing the visual features of the selected frame 254 based on the concatenated matrix. Such concatenated vector is referred to as frame feature(s) 256 herein.

In some embodiments, model weight module 216 can provide the frame feature(s) 256 associated with selected frame 254 as an input to an AI model trained to predict model weights associated with given content (e.g., weight prediction model 410). Weight prediction model 410 can be a multilayer perceptron (MLP) model that includes multiple connected layers. In some embodiments, two or more layers can be connected with Rectified Nonlinear Unit (ReLU) nonlinearity. An additional layer of the weight prediction model 410 can include a sigmoid layer that processes frame features 256.

In some embodiments, the MLP model is trained to predict the model weights associated with content of a media item 121 associated with the given frame features 256 by minimizing a downstream performance error associated with AI model 182. A loss associated with AI model 182 is defined by a task-specific loss function, such as a mean squares error loss function or a cross entropy loss function, which quantifies the error between an output of AI model 182 (e.g., the quality metric 260 obtained for a transformed frame 252) and ground truth data (e.g., the quality metric 260 obtained for the original corresponding frame). A final loss is backpropagated through an execution of AI model 182 (e.g., through a reshape operation) and back through the weight prediction model 410 to update only the parameters of the weight prediction model 410. A system performing the training of weight prediction model 410 (e.g., predictive system 180 or another system or component) can determine a parameter weight function based on the updated parameters, which can be applied by the weight prediction model 410 when faced with given frame features associated with a media item 121 (e.g., frame features 256). As indicated above, model weight module 216 can provide frame feature(s) 256 as an input to weight prediction model 410 and obtain one or more outputs of weight prediction model 410, which indicate predicted model weights associated with the frame feature(s) 256 (e.g., per the application of the determined function). Such model weights are referred to herein as content-based model weights 258.

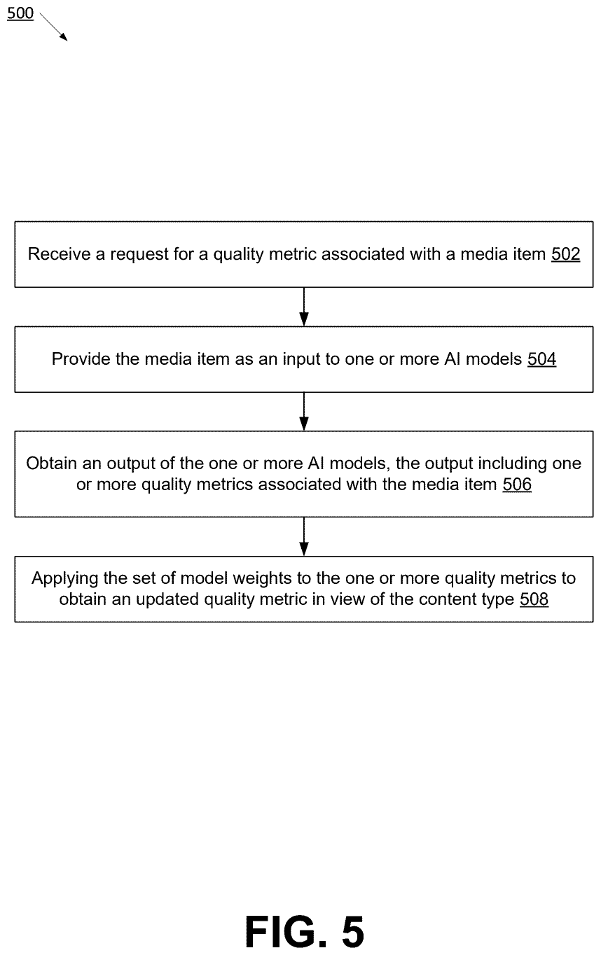

At block 310, processing logic modifies a model pipeline associated with a content sharing platform to include the set of model weights for application to an AI model trained to predict quality metrics associated with media items including content having the content type. A model pipeline 412 refers to an end-to-end repeatable workflow that takes incoming data, processes it, and passes it through a trained model to obtain outputs or predictions. In some embodiments, media attribute engine 152 (or another component of platform 120 and/or system 100) can update model pipeline 412 to include a content-based quality metric component 414, which applies model weights 258 to outputs of AI model 182. Media attribute engine 152 can update the model pipeline 412 to include content-based quality metric component 414 downstream of AI model 182, in some embodiments. In some embodiments, upon obtaining content-based model weights 258, model weight module 216 can update the model pipeline 412 by providing the model weights 258 to content-based quality metric component 414, which can apply the model weights 258 to a quality metric 260 predicted by AI model 182, as described below with respect to FIG. 5.

FIG. 5 is a block diagram of an example method 500 for content-based media attribute assessment, in accordance with implementations of the present disclosure. Method 500 can be performed by processing logic that can include hardware (circuitry, dedicated logic, etc.), software (e.g., instructions run on a processing device), or a combination thereof. In one implementation, some or all the operations of method 500 can be performed by one or more components of system 100 of FIG. 1. In some embodiments, some or all of the operations of method 500 can be performed by media attribute engine 152 and/or one or more components of predictive system 180.

At block 502, processing logic receives a request for a quality metric associated with a media item. In some embodiments, media item manager 132 can receive a media item 121 from a client device 102. Upon receiving the media item 121, media item manager 132 can transmit a request to media attribute engine 152 for a quality metric 260 (or other media attribute) associated with the media item 121. In some embodiments, the request can include an indication of a content type associated with media item 121. In other or similar embodiments, media attribute engine 152 can determine the content type associated with media item 121 as described above (e.g., based on metadata associated with media item 121, based on one or more outputs of another AI model, etc.).

At block 504, processing logic provides the media item as an input to one or more AI models. At block 506, processing logic obtains an output of the one or more AI models, the output including one or more quality metrics associated with the media item. Media attribute engine 152 can provide media item 121 as an input to AI model 182 and obtain one or more outputs, which can indicate a quality metric 260 associated with media item 121. In an illustrative example, the quality metric 260 can include a quality score (or other type of value) that reflects a visual quality or a technical quality associated with media item 121.

At block 508, processing logic applies the set of model weights to the one or more quality metrics to obtain an updated quality metric in view of the content type. In some embodiments, media attribute engine 152 can provide an indication of the content type associated with media item 121 to content-based quality metric component 414. Content-based quality metric component 414 can identify (e.g., from memory 250) content-based model weight(s) 258 associated with the content type and can apply the identified model weights 258 to the quality metric 260 included in the output(s) of AI model 182. In an illustrative example, content-based quality metric component 414 can multiply the quality metric 260 obtained for media item 121 to the identified content-based model weight(s) 258 to obtain the updated quality metric.

In some embodiments, media attribute engine 152 may provide media item 121 as an input to multiple AI models 182 that are each trained to predict quality metrics 260 associated with given media items 121. A first AI model 182A can include a lightweight vision language model that is trained to process images and/or text associated with a given media item 121. A second AI model 182B can include a video quality assessment (VQA) model that is trained to predict quality metrics 260 associated with a given media item 121. In some embodiments, media attribute engine 152 can determine the updated quality metric based on the quality metrics 260 obtained based on the outputs of the first AI model 182A and the second AI model 182B in accordance with Equation 1 below:

$${q}_{e} = α * {q}_{p} + ( 1 - α ) * {q}_{l} \qquad Equation 1$$

where qₑ represents the updated quality metric, a represents a content-based model weight 258, qₚ represents a quality metric 260 obtained based on one or more outputs of the first AI model 182A, and qₗ represents a quality metric 260 obtained based on one or more outputs of the second AI model 182B. It should be noted that Equation 1 is provided for purposes of example and illustration only and is not intended to be limiting. The updated quality metric can be determined in accordance with other techniques or equations, in accordance with embodiments of the present disclosure.

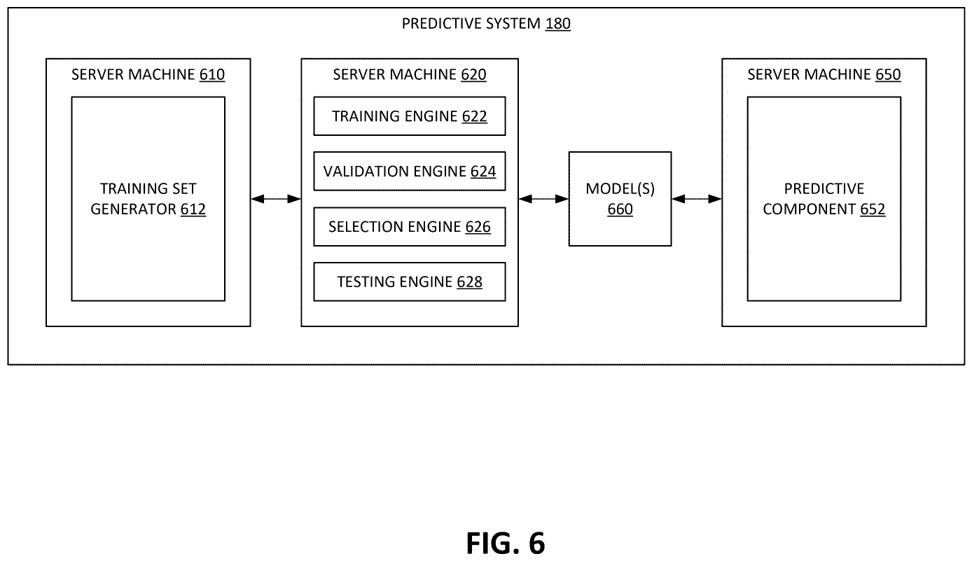

FIG. 6 is a block diagram of an example predictive system 180, in accordance with implementations of the present disclosure. As illustrated in FIG. 5, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 550). Training set generator 612 may be capable of generating training data (e.g., a set of training inputs and a set of target outputs) to train one or more AI model 660. In some embodiments, AI model 660 can include AI model 182 that predicts media attributes (e.g., quality metrics) associated with media items 121 of platform 120.

Training set generator 612 can generate a training dataset to train AI model 660 by obtaining a set of labeled media items 121 each associated with a quality metric 260. In some embodiments, training set generator 612 can identify media items 121 for inclusion in the training dataset (referred to as training media items herein) from one or more media item data stores, which can include a publicly available data store or a privately available data store (e.g., maintained by or otherwise associated with platform 120). The training media items can have a wide variety of characteristics (e.g., genre, motion, texture complexity, etc.) and distortion types (e.g., blurring, noise, frame drops, various degrees of resolution or bitrate degradation, etc.). In some embodiments, the quality metric 260 assigned to each training media item can include a mean opinion score derived from formal subjective experiments where viewers (e.g., human viewers) rate perceptual quality. The mean opinion score may serve as a ground truth label for the model's supervised learning process. In some embodiments, the training data items can reflect a broad spectrum of possible real-world media quality scenarios, from high definition, high-bitrate sources to highly compressed user-generated content.

In some embodiments, training set generator 612 can generate an input-output mapping based on the obtained training media items and the obtained quality metrics associated with such training media items. In an illustrative example, an input of the input-output mapping can be based on the obtained training videos and the output of the input-output mapping can include the quality metrics 260. Upon generating the input-output mapping, training set generator 612 can provide the input-output mapping to training engine 622 for training AI model 660.

Training engine 622 can train an AI model 660 using the training data from training set generator 612. The AI model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the AI model 660 that captures these patterns. The AI model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. In some embodiments, AI model 660 can include, but is not limited to, a video quality assessment (VQA) model (e.g., a no-reference VQA model, a full-reference VQA model), a neural network (e.g., a convolutional neural network (CNN) based model, a recurrent neural network (RNN) or long short-term memory (LSTM) based model, a transformer-based model, etc.), a quality of experience (QoE) prediction model (e.g., a supervised machine learning model, a reinforcement model, a hybrid model, etc.), and so forth.

Validation engine 624 may be capable of validating a trained machine learning model 660 using a corresponding set of features of a validation set from training set generator 612. The validation engine 624 may determine an accuracy of each of the trained machine AI 660 based on the corresponding sets of features of the validation set. The validation engine 624 may discard a trained AI model 660 that has an accuracy that does not meet a threshold accuracy. In some embodiments, the selection engine 626 may be capable of selecting a trained machine learning model 660 that has an accuracy that meets a threshold accuracy. In some embodiments, the selection engine 626 may be capable of selecting the trained AI model 660 that has the highest accuracy of the trained AI models 660.

The testing engine 628 may be capable of testing a trained AI model 660 using a corresponding set of features of a testing set from training set generator 612. For example, a first trained machine learning model 660 that was trained using a first set of features of the training set may be tested using the first set of features of the testing set. The testing engine 628 may determine a trained machine learning model 660 that has the highest accuracy of all of the trained machine learning models based on the testing sets.

As described above, predictive component 652 of server 650 may be configured to feed data as input to model 660 and obtain one or more outputs. In some embodiments, predictive component 652 can include or be associated with media item manager 132 and/or media attribute engine 152. In other or similar embodiments, predictive component 652 can include or be associated with another process or engine of system 100. For example, predictive component 652 can be associated with an encoding engine of system 100, a media item enhancement engine of system 100, and so forth. Predictive component 652 can provide media items 121 as an input to AI model 660 and can obtain one or more outputs including a predicted quality metric 260. Media item manager 132, media attribute engine 152, and/or other processes or engines of system 100 can use the quality metric 260 obtained based on the one or more outputs for use in the performance of any type of operation described above (e.g., determining optimal encoding settings or codecs for the media item 121, determining optimal enhancement operations to be performed with respect to the media item 121, etc.).

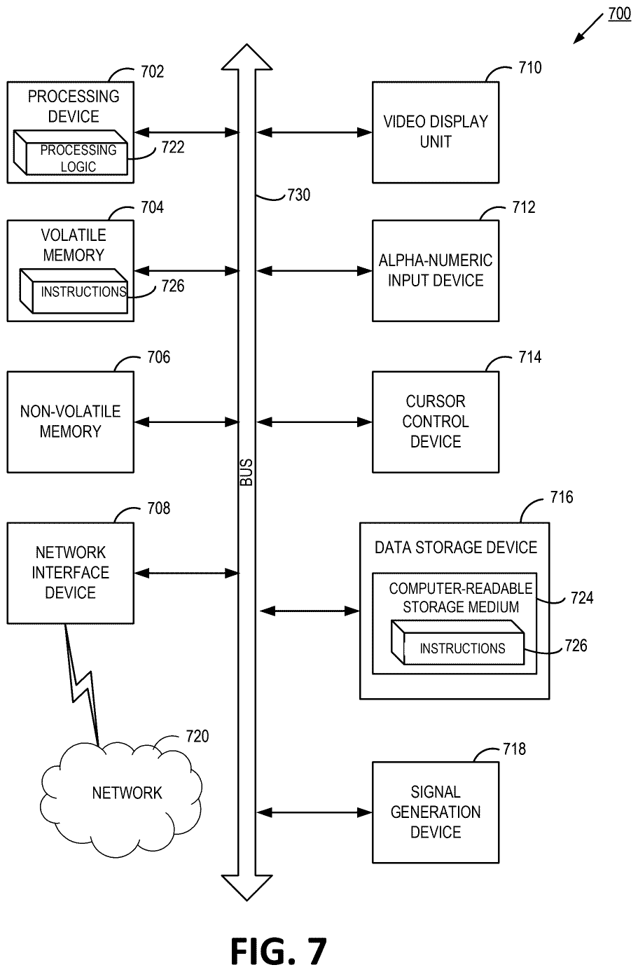

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, and the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
identifying a media item comprising a set of video frames each comprising initial content of a content type;
performing a spatial transformation operation with respect to the set of video frames to obtain a set of spatially transformed video frames;
identifying, in the set of spatially transformed video frames, one or more video frames comprising transformed content that satisfies one or more quality criteria;
determining a set of model weights associated with the transformed content of the identified one or more video frames; and
modifying a model pipeline associated with a content sharing platform to include the set of model weights to be applied to outputs of one or more artificial intelligence (AI) models trained to predict quality metrics for media items comprising content of the content type.

2. The method of claim 1, wherein determining the set of model weights associated with the transformed content comprises:
providing the transformed content as an input to an additional AI model trained to predict model weights associated with given content;
obtaining one or more outputs of the additional AI model; and
extracting the set of model weights associated with the transformed content from the obtained one or more outputs of the additional AI model.

3. The method of claim 2, wherein the additional AI model comprises a multilayer perceptron model comprising one or more of a plurality of layers having rectified linear unit (ReLU) non-linearity or a sigmoid layer.

4. The method of claim 1, further comprising:
providing the transformed content as an input to a vision encoder; and
obtaining one or more outputs of the vision encoder, the one or more outputs comprising a set of visual features representing the transformed content,
wherein the set of model weights associated with the transformed content is determined based on the set of visual features.

5. The method of claim 4, further comprising:
providing the set of visual features as an input to a concatenation operation;
obtaining one or more outputs of the concatenation operation, wherein the one or more outputs comprise a concatenated matrix representing the set of visual features.

6. The method of claim 5, further comprising:
providing concatenated matrix as an input to a spatial pooling operation; and
obtaining one or more outputs of the spatial pooling operation, wherein the one or more outputs comprise a concatenated vector representing the set of visual features based on the concatenated matrix,
wherein the set of model weights associated with the transformed content is determined based on the concatenated vector.

7. The method of claim 1, wherein the spatial transformation operation comprises at least one of a resizing operation, a stretching operation, a compression operation, or a cropping operation.

8. The method of claim 1, wherein identifying, in the set of spatially transformed video frames, one or more video frames comprising transformed content that satisfies one or more quality criteria comprises at least one of:
determining that a difference between a visual quality of the transformed content of the one or more video frames and a visual quality of the initial content of the set of video frames falls below a threshold difference,
determining that the visual quality of the transformed content of the one or more video frames exceeds a threshold visual quality, or
determining that the visual quality of the transformed content of the one or more video frames is higher than a visual quality of transformed content of one or more additional video frames of the set of spatially transformed video frames.

9. The method of claim 1, wherein the content type comprises at least one of a short-form content type, a long-form content type, a user-generated content type, a live-stream content type, an animated content type, a computer generated image (CGI) content type, an archival content type, or a restored content type.

10. The method of claim 1, further comprising:
receiving a request for a quality metric associated with an additional media item comprising content of the content type;
providing the additional media item as an input to one or more AI models;
obtaining an output of the one or more AI models, the output comprising one or more quality metrics associated with the additional media item; and
applying the set of model weights to the one or more quality metrics associated with the additional media item to obtain an updated quality metric in view of the content type.

11. A system comprising:
a memory; and
a set of one or more processing devices, the set of one or more processing devices to perform operations comprising:
identifying a media item comprising a set of video frames each comprising initial content of a content type;
performing a spatial transformation operation with respect to the set of video frames to obtain a set of spatially transformed video frames;
identifying, in the set of spatially transformed video frames, one or more video frames comprising transformed content that satisfies one or more quality criteria;
determining a set of model weights associated with the transformed content of the identified one or more video frames; and
modifying a model pipeline associated with a content sharing platform to include the set of model weights to be applied to outputs of one or more artificial intelligence (AI) models trained to predict quality metrics for media items comprising content of content type.

12. The system of claim 11, wherein determining the set of model weights associated with the transformed content comprises:
providing the transformed content as an input to an additional AI model trained to predict model weights associated with given content;
obtaining one or more outputs of the additional AI model; and
extracting the set of model weights associated with the transformed content from the obtained one or more outputs of the additional AI model.

13. The system of claim 12, wherein the additional AI model comprises a multilayer perceptron model comprising one or more of a plurality of layers having rectified linear unit (ReLU) non-linearity or a sigmoid layer.

14. The system of claim 11, wherein the operations further comprise:
providing the transformed content as an input to a vision encoder; and
obtaining one or more outputs of the vision encoder, the one or more outputs comprising a set of visual features representing the transformed content,
wherein the set of model weights associated with the transformed content is determined based on the set of visual features.

15. The system of claim 14, wherein the operations further comprise:
providing the set of visual features as an input to a concatenation operation;
obtaining one or more outputs of the concatenation operation, wherein the one or more outputs comprise a concatenated matrix representing the set of visual features.

16. The system of claim 15, wherein the operations further comprise:
providing concatenated matrix as an input to a spatial pooling operation; and
obtaining one or more outputs of the spatial pooling operation, wherein the one or more outputs comprise a concatenated vector representing the set of visual features based on the concatenated matrix,
wherein the set of model weights associated with the transformed content is determined based on the concatenated vector.

17. The system of claim 11, wherein the spatial transformation operation comprises at least one of a resizing operation, a stretching operation, a compression operation, or a cropping operation.

18. A non-transitory computer-readable medium comprising instructions that, when executed by a processor, cause the processor to perform operations comprising:
identifying a media item comprising a set of video frames each comprising initial content of a content type;
performing a spatial transformation operation with respect to the set of video frames to obtain a set of spatially transformed video frames;
identifying, in the set of spatially transformed video frames, one or more video frames comprising transformed content that satisfies one or more quality criteria;
determining a set of model weights associated with the transformed content of the identified one or more video frames; and
modifying a model pipeline associated with a content sharing platform to include the set of model weights to be applied to outputs of one or more artificial intelligence (AI) models trained to predict quality metrics for media items comprising content of the content type.

19. The non-transitory computer-readable medium of claim 18, wherein determining the set of model weights associated with the transformed content comprises:
providing the transformed content as an input to an additional AI model trained to predict model weights associated with given content;
obtaining one or more outputs of the additional AI model; and
extracting the set of model weights associated with the transformed content from the obtained one or more outputs of the additional AI model.

20. The non-transitory computer-readable medium of claim 19, wherein the additional AI model comprises a multilayer perceptron model comprising one or more of a plurality of layers having rectified linear unit (ReLU) non-linearity or a sigmoid layer.
